(19) United States
(12) Patent Application Publication
(10) Pub. No.: US 2012/0305015 A1
(43) Pub. Date: Dec. 6, 2012

(54) COATED PAPER FILTER

(76) Inventors: Andries D. Sebastian, Clemmons, NC (US); Stephen Benson Sears, Siler City, NC (US); Steven L. Alderman, Lewisville, NC (US)

(21) Appl. No.: 13/118,930

(22) Filed: May 31, 2011

(51) Int. Cl. A24D 3/10; A24D 3/08; B05D 5/02; A24D 3/06

(52) U.S. Cl. 131/332; 131/331; 131/345; 427/206; 427/244

(57) ABSTRACT

A biodegradable paper substrate and/or biodegradable fiber (including fiber tow) may be coated with cellulose acetate and/or plasticized cellulose acetate for use in a filter material configured for application in a filter of a smoking article. Flocking and/or fibrillation methods may be used to deposit and/or generate a plurality of fibers that may protrude beyond a surface of the biodegradable substrate material. A filter made in accordance with this design may also include non-biodegradable material.

### TECHNICAL FIELD

The present invention relates to products made or derived from tobacco, or that otherwise incorporate tobacco, and are intended for human consumption. More particularly, the invention pertains to filter compositions, including paper compositions, for smoking articles such as cigarettes.

### BACKGROUND

Popular smoking articles, such as cigarettes, have a substantially cylindrical rod-shaped structure and include a charge, roll or column of smokable material, such as shredded tobacco (e.g., in cut filler form), surrounded by a paper wrapper, thereby forming a so-called “smokable rod” or “tobacco rod.” Normally, a cigarette has a cylindrical filter element aligned in an end-to-end relationship with the tobacco rod. Typically, a filter element comprises plasticized cellulose acetate tow circumscribed by a paper material known as “plug wrap.” Typically, the filter element is attached to one end of the tobacco rod using a circumscribing wrapping material known as “tipping paper.” It also has become desirable to perforate the tipping material and plug wrap, in order to provide dilution of drawn mainstream smoke with ambient air. Descriptions of cigarettes and the various components thereof are set forth in Tobacco Production, Chemistry and Technology, Davis et al. (Eds.) (1999).

A cigarette is employed by a smoker by lighting one end thereof and burning the tobacco rod. The smoker then receives mainstream smoke into his/her mouth by drawing on the opposite end (e.g., the filter end) of the cigarette, until the tobacco rod is partially or completely consumed, after which the remaining cigarette portion is discarded.

The discarded portion of the cigarette rod typically is primarily composed of the filter element, although it may include most or all of a tobacco rod. In general, cigarette filters include solvent cross linked cellulose acetate fiber bundles wrapped in two layers of paper. The first layer of paper, often referred to as plug wrap, holds the fiber bundle together in a rod form and may include a glue line to anchor the fiber bundle to the plug wrap paper; the second layer, often referred to as the tipping, is fully adhered to the plug wrap and attaches the filter tube to the wrapping material surrounding the cigarette's tobacco rod. Cigarette filters may be slow to degrade or disperse in some environments. This is generally attributed to the tightly bound nature of the filter plug's design which is configured to provide a specified filtering effect, but which may insulate the majority of the filter from certain environmental effects upon disposal.

The most commonly used polymer in cigarette filter manufacture is cellulose acetate that has a degree of acetate substitution of about 2.5 acetate groups per anhydroglucose unit group. During manufacture, the acetate polymer typically is extruded as a fiber tow, and mixed with one or more plasticizers (e.g., triacetin, polyethylene glycol, glycerin). Cellulose acetate tow processes are set forth, for example, in U.S. Pat. Nos. 2,953,838 to Crawford et al. and 2,794,239 to Crawford et al., which are incorporated by reference herein. After assembly of tow into filter-ready material, the plasticizers soften the fiber and enable inter-fiber bonds to form and harden a filter to a desired hardness/consistency. The surface chemistry of cellulose acetate and plasticizer provide for a smoke flavor that is widely desired and accepted by smokers. This may be due in part to their well-known ability to reduce naturally occurring phenolic compounds from tobacco smoke. Certain other filter designs/formulations may provide a different smoke flavor. To date, non-cellulose acetate tow filters have not generally been accepted nor met with commercial success.

A number of approaches have been used in the art to promote an increased rate of degradation of filter elements in various disposal environments. For example, U.S. patent application Ser. Nos. 12/917,171, filed Nov. 1, 2010; 12/963,275, filed Dec. 8, 2010; and 12/827,618, filed Jun. 30, 2010, which are incorporated by reference herein, propose filters and other structures for use with tobacco products that include biodegradable polymers such as polylactic acid.

It may be desirable to provide degradable cigarette filter materials that also remove one or more components of mainstream aerosol.

### BRIEF SUMMARY

A biodegradable paper substrate material may be coated with cellulose acetate and/or plasticized cellulose acetate for use in a filter material configured for application in a filter of a smoking article. A filter made in accordance with this design also may include non-biodegradable fiber, or fiber that degrades at different rates and/or under different conditions. Embodiments of cigarette filter compositions presented here may provide filter materials configured to be biodegradable in a variety of common disposal environments including, for example, landfills, private and industrial composting, open-air surfaces, aerobic, and/or anaerobic aquatic locations. In addition, the present embodiments may provide filter material surfaces modified to include acetate groups and conventional plasticizers to provide the smoke flavor commonly desired by smokers of filtered smoking articles such as cigarettes. Preferred embodiments may simultaneously provide both biodegradability and desirable flavor, which combination generally has seemed to elude some existing filter technologies.

Embodiments disclosed herein relate to a smoking article and associated methods, and in particular, a rod-shaped smoking article (e.g., a cigarette). The smoking article includes a lighting end (i.e., an upstream end) and a mouth end (i.e., a downstream end). A mouth end piece is located at the extreme mouth end of the smoking article, and the mouth end piece allows the smoking article to be placed in the mouth of the smoker to be drawn upon. The mouth end piece has the form of a filter element comprising a filter material. The filter material may incorporate an effective amount of a biodegradable material (or other degradable polymer material) configured for increasing the rate of degradation of the filter material upon disposal. This may include non-fibrous biodegradable material incorporated within the biodegradable material. The degradable material described herein may further speed up and enhance degradation by allowing formation of voids within a filter formed from the filter material as the degradable material decomposes, thus increasing available surface area within the filter material for contact with the environment and/or microorganisms therein.

In one aspect a filter material and/or a filter used in a smoking article may include at least one segment of a biodegradable paper substrate material and a cellulose acetate coating and/or plasticized cellulose acetate coating disposed upon the biodegradable substrate material. The cellulose acetate and/or plasticized cellulose acetate coating may be disposed on surfaces of the biodegradable substrate material.

### BRIEF DESCRIPTION OF THE DRAWINGS

FIG. 1 is an embodiment of a smoking article.

FIG. 2 illustrates degradation rates of exemplary natural cellulosic fibers, thermoplastic fibers, and blends thereof.

FIG. 3 is an end view of an exemplary paper-based filter segment.

FIG. 4 is a longitudinal section view of the filter segment of FIG. 3.

### DETAILED DESCRIPTION

Embodiments are described with reference to the drawings in which like elements are generally referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments of the present invention, such as—for example—conventional fabrication and assembly. As used in this specification and the claims, the singular forms “a,” “an,” and “the” include plural referents unless the context clearly dictates otherwise. As used herein, “fiber” is intended to include continuous and non-continuous or staple fibers (including for example monofilament fibers, fiber/fibrous tow, braided fibers, spun fibers, wound fibers, mono-component fibers, bi-component fibers, multi-component fibers, etc.), and each reference to any type of fiber should be considered generic except for those cases where one of skill in the art would recognize that the context is technically limited to a single fiber type.

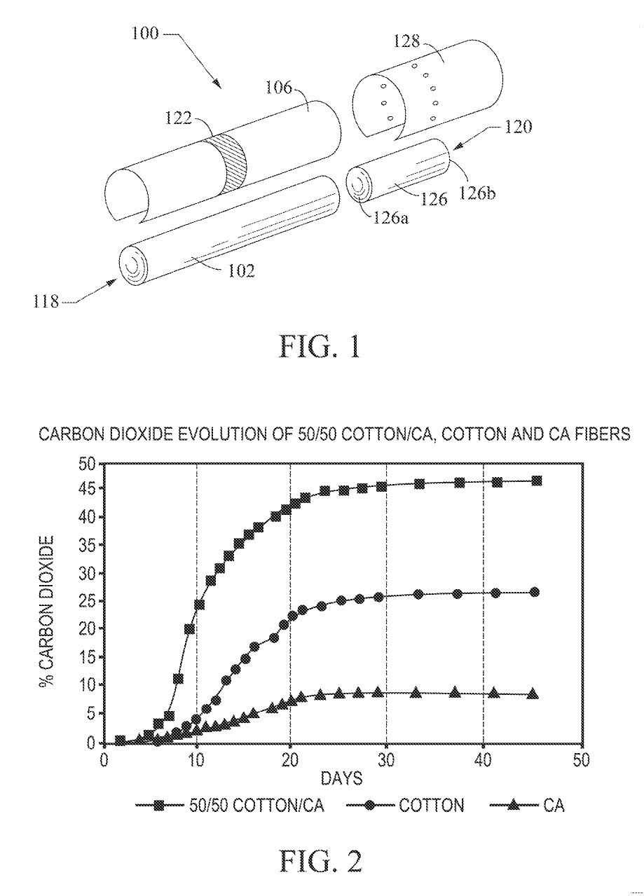

As shown in FIG. 1, a smoking article 100 may be embodied as a cigarette. The cigarette 100 may include a generally cylindrical rod 102 of a charge or roll of smokable filler material contained in a circumscribing wrapping material 106. The rod 102 is conventionally referred to as a “tobacco rod.” The ends of the tobacco rod 102 may be open to expose the smokable filler material. The cigarette 100 may include a band 122 (e.g., a printed coating including a film-forming agent, such as starch, ethylcellulose, or sodium alginate) applied to the wrapping material 106, and that band circumscribes the cigarette rod in a direction transverse to the longitudinal axis of the cigarette. That is, the band 122 provides a cross-directional region relative to the longitudinal axis of the cigarette. The band 122 may be printed on the inner surface of the wrapping material (i.e., facing the smokable filler material), or less preferably, on the outer surface of the wrapping material. Although the cigarette may possess a wrapping material having one optional band, the cigarette also may possess wrapping material having further optional spaced bands numbering two, three, or more, which bands may be configured to inhibit the ignition propensity and/or ability of the cigarette to remain lit if not in active use.

A filter element 126 may be disposed at the mouth end 120 of the tobacco rod 102, and the lighting end 118 is positioned at the opposite end. The filter element 126 may be axially aligned in an end-to-end relationship with and preferably abutting the tobacco rod 102. The filter element 126 may have a generally cylindrical shape, and its diameter may be substantially the same as the diameter of the tobacco rod. The proximal and distal ends 126a, 126b (respectively) of the filter element 126 may permit the passage of air and smoke therethrough.

Embodiments of filters in the present disclosure include substrates of a biodegradable paper composition or other material suitable for forming a substrate for a filter material. Other suitable materials may include, for example, biodegradable polymers. Such other suitable materials also are described in U.S. patent application Ser. No. 12/827,839, filed Jun. 30, 2010 and U.S. Patent Application Ser. No. 12/963,275, filed Dec. 8, 2010, each incorporated by reference herein in its entirety. The substrate material may be coated with cellulose acetate and/or plasticized cellulose acetate. Additionally, the coated substrate material may be fibrillated or flocked with cellulose acetate fibers or other biodegradable fibers coated with cellulose acetate and/or plasticized cellulose acetate. The coated and fibrillated or flocked paper material may be gathered using known methods to form a filter suitable for use in a smoking article.

Preferred paper compositions will include a high degree of biodegradability. The compositions may be fibrillatable or fiber-forming and/or may be capable of being gathered to form cigarette filters (including during manufacture with standard or modified filter-making equipment known in the art). Preferred constructions—whether paper-based or polymeric fiber—preferably will include surface chemistries of coatings, including cellulose acetate based and/or plasticized cellulose acetate chemistries, that may provide a flavor profile for smokers that is substantially similar or even identical to that associated with traditional filter configurations.

As shown in FIG. 2, filter materials according to the various embodiments of the present disclosure may exhibit increased degradation, including biodegradation, rates with respect to traditional filter materials. Particularly, filter materials according to the various embodiments of the present disclosure may exhibit increased degradation rates with respect to traditional cellulose acetate tow-based filter materials. Additionally, filter materials according to the various embodiments of the present disclosure may exhibit increased degradation rates with respect to natural cellulosic fibers such as, for example, cotton fibers. U.S. Pat. No. 5,783,505 to Ducket et al., which is incorporated by reference herein, describes compostable and biodegradable compositions including blends of natural cellulosic fibers and thermoplastic biodegradable fibers. Combining a natural cellulosic fiber (e.g., cotton) with a thermoplastic fiber (e.g., cellulose acetate) may result in a synergistic effect in terms of biodegradability and compostablity. Such an effect may be evidenced by an increased carbon dioxide evolution rate of a 50/50 cotton/CA blend relative to that of cotton alone, as shown in FIG. 2. Similar synergistic effects may be achieved by combining cellulose acetate and/or plasticized cellulose acetate with a paper composition or other biodegradable substrate material for use in a filter of a smoking article.

The paper composition substrate may include at least one cellulosic material and at least one inorganic filler. Additionally, the paper may include other additives or ingredients employed in the paper making industry. Exemplary cellulosic materials may include, for example, flax fibers, hardwood pulp (preferably unbleached), softwood pulp (preferably unbleached), cotton fibers, tobacco parts (e.g., tobacco laminae and stem pieces), and the like. Exemplary inorganic filler materials may include, for example, molecular sieve particles, agglomerated calcium carbonate particles, calcium carbonate particles, calcium sulfate fibers, precipitated magnesium hydroxide gel, clay particles, and the like. One example of a suitable paper composition is described in U.S. Pat. No. 5,568,819 to Gentry et al., which is incorporated by reference herein.

The materials which make up the paper may be incorporated into the paper during manufacture using the paper making process. Components such as sizing agents and moisture also may be incorporated into the paper. Typically, the amount of sizing agent incorporated into the paper may be less than about 5 weight percent, and often about 0.1 to about 3 weight percent. The moisture content of the paper may range from about 5 to about 15 weight percent, and often about 8 to about 12 weight percent. Flavoring agents and other smoke modifying agents (e.g., tobacco extracts, heat treated tobacco extracts, spearmint, vanillin, anethole, and menthol) also may be incorporated into the paper. Exemplary tobacco extracts may be spray dried extracts such as those described in U.S. Pat. No. 5,060,669 to White et al. Certain paper compositions may be absent of inorganic fillers (e.g., calcium carbonate particles), and may be absent of thermoplastic fibers (e.g., polyethylene, polypropylene, or polyester fibers).

The physical properties of the paper substrate may vary. The thickness of the paper typically may range from about 0.08 mm to about 0.2 mm, often about 0.13 mm to about 0.18 mm. The basis weight of the paper typically may range from about 35 g/m² to about 60 g/m², often about 45 g/m² to about 55 g/m². The tensile strength of the paper preferably may be at least about 800 g/in, typically from about 1100 g/in to about 2300 g/in, although papers having greater tensile strengths may be employed. The porosity (i.e., inherent porosity) of the paper preferably may be quite high, but typically may range from about 50 to about 300 CORESTA units, often about 70 to about 200 CORESTA units. The paper may be electrostatically perforated to provide a relatively high net permeability. Typically, papers having exceedingly low porosities may have a tendency to provide relatively low removal efficiencies of gas phase components of mainstream smoke.

A water soluble cellulose acetate polymer or water insoluble cellulose acetate based dispersion (that may include plasticized cellulose acetate) may be applied to the biodegradable or otherwise degradable substrates described herein. Stated differently, a coating composition for application to a biodegradable substrate material may include water soluble cellulose acetate polymer or water insoluble cellulose acetate dispersions. Non-aqueous cellulose acetate solutions or dispersions such as, for example, those containing alcohols also may be applied to a biodegradable substrate as described herein. A preferred coating for coating paper compositions to be used in cigarette filters according to embodiments of the present invention may have about 0.5 to about 1.2 acetyl substitution per unit of anhydroglucose group of the cellulose acetate polymer. Preferred cellulose acetate polymers suitable for paper coatings are described in U.S. Pat. No. 4,983,730 to Domeshek et al., which is incorporated by reference herein, where such compositions comprise a 85-98 weight % of a low molecular weight water soluble cellulose acetate polymer having a solution viscosity from 5-50 cps and from 2-15 weight % of a higher molecular weight water soluble acetate polymer with a solution viscosity of greater than 100. Specifically, these polymers may form clear, strong, flexible films that easily may be dried at room temperature. Cellulose acetate polymers having these characteristics are known in the art to be water soluble and to function very well as film-forming agents. See, for example Wheatley (2007) in “Water Soluble Cellulose Acetate: A Versatile Polymer for Film Coating”; Drug Development, and Industrial Pharmacy, 33:281-90. Other water soluble polymers containing acetate functionality may be employed such as cellulose acetate phthalate and cellulose acetate mellitate. For these polymers the water solubility may be dependent on the degree of phthalate or mellitate substitution, the pH, as well as the molecular weight.

Water insoluble cellulose acetate polymer dispersions may include, for example, cellulose acetate phthalate, cellulose acetate succinate, cellulose acetate butyrate, and/or cellulose acetate mellitate polymers that may be formulated as aqueous dispersions. One such dispersion is commercially available as Aquacoat® CPD Cellulose acetate phthalate dispersion (available from FMC Biopolymer). Plasticized cellulose acetate generally may have thermoplastic properties and may best be applied to underlying paper, polymeric, or other substrates through any coating process known or developed for compositions with its physical properties. For example, plasticized cellulose acetate may be printed, coated, or otherwise applied to paper substrates to form the coated paper materials described herein. It may be co-extruded with one or more biodegradable polymeric substrates.

During a method of making a coated paper, water soluble cellulose acetate polymer or water insoluble cellulose acetate dispersions may be used as a finish/coating that may be applied to a biodegradable substrate. Non-aqueous cellulose acetate solutions or dispersions also may be used as a finish/coating for a biodegradable substrate. For example, solutions or dispersions containing alcohols may be used. The phrase “solution or dispersion” should be clearly understood as including any aqueous or non-aqueous mixture where cellulose acetate is soluble (a solution), where it is generally or substantially insoluble (a dispersion), and any combination thereof (e.g., for aqueous mixtures containing both water-soluble and water-insoluble cellulose acetate(s)). For example, a cellulose acetate composition may be selected or adapted from compositions described in U.S. Pat. No 4,983,730 to Domeshek et al., which is incorporated by reference herein. The polymer concentration in this aqueous solution may be from about 0.5% to about 50% by weight. This solution may provide for application to, and formation of a cellulose acetate film on, for example, the surface of the paper composition substrate.

Additionally, cellulose acetate fibers may be deposited on at least one surface of the coated paper by flocking. Alternatively, other biodegradable fibers coated with cellulose acetate may be deposited on at least one surface of the coated paper. The resulting cellulose acetate coated paper and/or cellulose acetate coated and flocked paper may have surface chemistries similar to those of currently-used cellulose acetate fiber tow, but may be significantly more biodegradable. The cellulose acetate coating may also allow conventional tow-plasticizers to be applied to generate desired filter hardness. The surfaces in a filter formed therefrom may have a surface chemistry similar to that of a traditional cellulose acetate fiber tow filter, and may provide a similar interaction with mainstream aerosol that most preferably may not adversely affect a smoker's perception of the flavor while smoking a cigarette incorporating a filter embodiment as described herein.

In one method of manufacturing coated paper compositions for use in filters, at least one surface of a paper composition or other paper material, such as those known in the art or developed for use in filters of smoking articles, may be coated with a cellulose acetate solution (as described above). In other words, a coating composition may be applied to a biodegradable substrate material to form a coated biodegradable substrate material. It should be noted that a cellulose acetate dispersion may be used instead of and/or in addition to a cellulose acetate solution. Preferably, multiple surfaces (e.g., both a front surface and a back surface) of a sheet of a paper composition may be coated with a cellulose acetate solution. The solution may be applied to the paper substrate in one of several ways known in the art. For example, the treatment may be done by dipping, spraying, and/or printing (e.g., gravure printing) the cellulose acetate and/or plasticized cellulose acetate onto the substrate.

Particularly when the substrate is a biodegradable paper material configured for use in a filter, it may be desirable to apply plasticized cellulose acetate by a gravure printing process and/or by a hot-melt process (as is known in the art to apply generally thermoplastic material to paper or other substrates). The solution may be dried following application to the paper substrate. After drying, the coated paper may be plasticized with a conventional or other plasticizing agent such as, for example, triacetin. Alternatively, the plasticizer may be added along with the cellulose acetate solution then dried. This method may be used with biodegradable fiber-forming polymers discussed herein. The resulting filter will include cellulose acetate-coated biodegradable material. The majority surface area may be similar to traditional cellulose acetate filters.

In another method of manufacturing coated paper compositions, a paper composition substrate may be treated with a cellulose acetate solution with a standard coating process, then subjected to fibrillation to form cellulose acetate-coated fibers extending from at least one surface of the paper. In other words, the coated biodegradable substrate material may be fibrillated to generate a plurality of fibers protruding beyond a surface thereof. The coated paper may be fibrillated by any known means. For example, conventional mechanical fibrillation generally may be performed with a rotating drum or roller having cutting elements such as needles or teeth in contact with the moving paper. The teeth may fully or partially penetrate the surface of the paper to impart a fibrillated surface thereto. Other similar mechanical treatments are known and may include, for example, twisting, brushing (as with a porcupine roller), rubbing (e.g., with leather pads), and flexing. The fibers that may be obtained by such conventional fibrillation processes typically are macroscopic in size, generally 70 microns to several hundreds of microns in cross section. Alternatively, the coated paper may be fibrillated by imparting sufficient fluid energy thereto to produce a fibrillated surface, for example, by contacting a portion of at least one surface of the paper with a high-pressure fluid. Exemplary fibrillation methods are described in U.S. Pat. No. 6,646,019 to Perez et al. A coated paper may be more effectively fibrillated than a corresponding uncoated paper substrate material. Fibrillation effectively may be enhanced by the presence of a cellulose acetate film on a surface of the paper.

In each of these and the other applications or embodiments, the cellulose acetate may be embodied as plasticized cellulose acetate. That is, the cellulose acetate may have been plasticized with triacetin or another plasticizing agent before being applied to the paper, fibers, polymer fiber, or other biodegradable substrate configured for use within principles of the present disclosure. For fibrillatable or fiber-forming substrates, particularly polymer-based substrates, it may be preferable to form the fibers before applying plasticized cellulose acetate.

A filter material of the present invention may include at least one sheet of biodegradable substrate material including a coating of cellulose acetate. The sheet of biodegradable substrate material may be formed using known processes. For example, the sheet may be formed by paper making or weaving processes. In one aspect, a method of making a coated sheet may include steps of: coating at least one surface of the sheet with a solution or dispersion of cellulose acetate (and/or coating at least one surface of the sheet with plasticized cellulose acetate); and drying the sheet. In certain embodiments, the coated sheet may include one or more of the biodegradable materials discussed herein. In certain other embodiments, the coated sheet may consist of, consist essentially of, or include a majority composition of (i.e., consist mostly of), one or more of the biodegradable materials discussed herein.

A solution of cellulose acetate may be embodied as an aqueous and/or non-aqueous solution of cellulose acetate, where the cellulose acetate has a degree of acetyl substitution of about 0.5 to about 1.2. The solution of cellulose acetate may be embodied as an aquatic solution of water-soluble cellulose acetate, where such compositions comprise a 85-98 weight % of a low molecular weight water soluble cellulose acetate polymer having a solution viscosity from 5-50 cps and from 2-15 weight % of a higher molecular weight water soluble acetate polymer with a solution viscosity of greater than 100 cps. If the film-forming finish is a cellulose acetate based aqueous dispersion such as cellulose acetate phthalate or cellulose acetate mellitate, an appropriate amount of the dispersion may be used to form a uniform film on the sheet surface.

In another embodiment, a coated paper produced by above-described methods may be coated with cellulose acetate and/or flocked with conventional cellulose acetate fibers and/or other biodegradable fibers. Alternatively, or in addition, the biodegradable sheet may be coated with cellulose acetate and/or flocked with conventional plasticized cellulose acetate fibers and/or other biodegradable fibers. The other biodegradable fibers may be coated with cellulose acetate and/or plasticized cellulose acetate. In any of these examples, plasticized cellulose acetate may be substituted for cellulose acetate and cellulose acetate may be substituted for plasticized cellulose acetate. Flocking may be the method/structure for coating with cellulose acetate and/or plasticized cellulose acetate. Such substitutions are within the scope of this disclosure. The other biodegradable fibers may be formed from, for example, starch, cellulosic or other organic plant-derived fibrous materials (e.g., cotton, wool, cedar, hemp, bamboo, kapok, or flax), regenerated cellulose, polyvinyl alcohol, aliphatic polyesters, aliphatic polyurethanes, polyhydroxy alkanoates, polyanhydrides, polybutylene succinate, polybutylene succinate adipate, polyesteramide, and copolymers and blends thereof. Exemplary aliphatic polyesters may include, for example, polyglycolic acid (PGA), polylactic acid (PLA) (e.g., poly(L-lactic acid) or poly(DL-lactic acid)), polyhydroxy butyrate (PHB), polyhydroxy valerate (PHV), polycaprolactone (PCL), and copolymers thereof.

Flocking may be accomplished by any known method including, for example, electrostatic flocking. An adhesive may be applied to the coated biodegradable sheet prior to or during flocking to retain the fibers on the sheet. Alternatively, the cellulose acetate film of the coated biodegradable sheet may serve as an adhesive to retain the fibers. A filter formed in this manner may have a different biodegradability profile than a filter where at least one biodegradable fiber is coated, a plurality of biodegradable fibers is coated, or substantially all biodegradable fibers or other substrate materials are coated, but may provide for a desirable flavor profile. Such embodiments may provide for improved dispersability of the cellulose acetate fibers which may enhance their ability to degrade and may lessen or even minimize the congestion and/or accumulation of cellulose acetate associated with existing cellulose acetate filters.

A filter material formed by these or other methods may be assembled into a filter configured for use in a smoking article, including that it may be treated with one or more plasticizing agents. A filter material configured for use as part of a smoking article may include a paper composition and/or a plurality of fibers, at least one of which may include a biodegradable material, where cellulose acetate and/or plasticized cellulose acetate may be provided on at least one paper composition and/or fiber. Each of the filter materials and combinations thereof may be assembled into a filter 126 of the type known and used in smoking articles such as, for example, the cigarette 100 shown in FIG. 1. Other smoking article configurations such as, for example, in Eclipse® brand cigarettes, cigarillos, and/or other smoking articles may incorporate filter materials and filters of the present invention.

During use, the smoker typically lights the lighting end 118 of the cigarette 100 using a match or cigarette lighter, whereupon the smokable material 102 begins to burn. The mouth end 120 of the cigarette 100 is placed in the lips of the smoker. Thermal decomposition products (e.g., components of tobacco smoke) generated by the burning smokable material 102 are drawn through the cigarette 100, through the filter element 126, and into the mouth of the smoker. Following use of the cigarette 100, the filter element 126 and any residual portion of the tobacco rod 102 may be discarded.

The dimensions of a representative cigarette 100 may vary. Preferred cigarettes are rod-shaped, and may have diameters of about 7.5 mm (e.g., circumferences of about 20 mm to about 27 mm, often about 22.5 mm to about 25 mm); and may have total lengths of about 70 mm to about 120 mm, often about 80 mm to about 100 mm. The length of the filter element 30 may vary. Typical filter elements may have total lengths of about 15 mm to about 40 mm, often about 20 mm to about 35 mm. For a typical dual-segment filter element, the downstream or mouth end filter segment often may have a length of about 10 mm to about 20 mm; and the upstream or tobacco rod end filter segment often may have a length of about 10 mm to about 20 mm.

Various types of cigarette components, including tobacco types, tobacco blends, top dressing and casing materials, blend packing densities and types of paper wrapping materials for tobacco rods may be employed. See, for example, the various representative types of cigarette components, as well as the various cigarette designs, formats, configurations and characteristics, that are set forth in Johnson, Development of Cigarette Components to Meet Industry Needs, 52nd T.S.R.C. (Sept., 1998); U.S. Pat. Nos. 5,101,839 to Jakob et al.; 5,159,944 to Arzonico et al.; 5,220,930 to Gentry and 6,779,530 to Kraker; 7,237,559 to Ashcraft et al.; 7,234,471 to Fitzgerald et al.; and 7,565,818 to Thomas et al.; and U.S. Pat. Publication Nos. 2005/0066986 to Nestor et al.; 2007/0056600 to Coleman, III et al.; and 2007/0246055 to Oglesby, each of which is incorporated by reference herein. The entire smokable rod may be composed of smokable material (e.g., tobacco cut filler) and a layer of circumscribing outer wrapping material.

Filter material can vary, and can be any material of the type that can be employed for providing a tobacco smoke filter for cigarettes. Traditional cigarette filter material may be used, such as gathered paper, carbon paper, cellulose acetate tow, gathered cellulose acetate web, polypropylene tow, gathered cellulose acetate web, strands of reconstituted tobacco, or the like. One filter material that may provide a suitable filter rod is cellulose acetate tow having 3 denier per filament and 40,000 total denier. As another example, cellulose acetate tow having 3 denier per filament and 35,000 total denier may provide a suitable filter rod. As another example, cellulose acetate tow having 8 denier per filament and 40,000 total denier may provide a suitable filter rod. For further examples, see the types of filter materials set forth in U.S. Pat. Nos. 3,424,172 to Neurath; 4,811,745 to Cohen et al.; 4,925,602 to Hill et al.; 5,225,277 to Takegawa et al. and 5,271,419 to Arzonico et al.; each of which is incorporated by reference herein.

Normally a plasticizer such as triacetin or carbowax may be applied to the filamentary tow in traditional amounts using known techniques. In one embodiment, the plasticizer component of the filter material may include triacetin and carbowax in a 1:1 ratio by weight. The total amount of plasticizer generally may be about 4 to about 20 percent by weight, preferably about 6 to about 12 percent by weight. Other suitable materials or additives used in connection with the construction of the filter element will be readily apparent to those skilled in the art of cigarette filter design and manufacture. See, for example, U.S. Pat. No. 5,387,285 to Rivers, which is incorporated by reference herein.

Filamentary tow, such as cellulose acetate, may be processed using a conventional filter tow processing unit such as a commercially available E-60 supplied by Arjay Equipment Corp., Winston-Salem, N.C. Other types of commercially available tow processing equipment, as are known to those of ordinary skill in the art, similarly may be used.

The filter elements disclosed herein may include a plurality of longitudinally-extending segments. Each segment may have varying properties and may include various materials capable of filtration or adsorption of particulate matter and/or vapor phase compounds. Typically, a filter element of the invention may include 1 to 6 segments, and frequently may include 2 to 4 segments. One or more of the segments may include one or more of the biodegradable and/or otherwise degradable components discussed herein, and may be coated with cellulose acetate.

Biodegradability may be measured, for example, by placing a sample in environmental conditions expected to lead to decomposition, such as placing a sample in water, a microbe-containing solution, a compost material, or soil. The degree of degradation may be characterized by weight loss of the sample over a given period of exposure to the environmental conditions. Preferred rates of degradation for certain filter element embodiments of the invention may include a weight loss of at least about 20% after burial in soil for 60 days or a weight loss of at least about 30% after 15 days of exposure to a typical municipal composter. However, rates of biodegradation may vary widely depending on the type of degradable particles used, the remaining composition of the filter element, and the environmental conditions associated with the degradation test. U.S. Pat. Nos. 5,970,988 to Buchanan et al. and 6,571,802 to Yamashita provide exemplary test conditions for degradation testing.

The process for making filter elements according to the invention may vary, but a process for making cellulose acetate filter elements typically may begin with forming cellulose fibers. The first step in conventional cellulose acetate fiber formation is esterifying a cellulose material. Cellulose is a polymer formed of repeating units of anhydroglucose. Each monomer unit has three hydroxyl groups available for ester substitution (e.g., acetate substitution). Cellulose esters may be formed by reacting cellulose with an acid anhydride. To make cellulose acetate, the acid anhydride is acetic anhydride. Cellulose pulp from wood or cotton fibers typically may be mixed with acetic anhydride and acetic acid in the presence of an acid catalyst such as sulfuric acid. The esterification process of cellulose often may result in essentially complete conversion of the available hydroxyl groups to ester groups (e.g., an average of about 2.9 ester groups per anhydroglucose unit). Following esterification, the polymer typically may be hydrolyzed to drop the degree of substitution (DS) to about 2 to about 2.5 ester groups per anhydroglucose unit. The resulting product typically may be produced in flake form that may be used in subsequent processing.

To form a fibrous material, the cellulose acetate flake typically may be dissolved in a solvent (e.g., acetone, methanol, methylene chloride, or mixtures thereof) to form a viscous solution. The concentration of cellulose acetate in the solution typically may be about 15 to about 35 percent by weight. Additives such as whitening agents (e.g., titanium dioxide) may be added to the solution if desired. The resulting liquid is sometimes referred to as a liquid “dope.” The cellulose acetate dope may be spun into filaments using a solution-spinning technique, which entails extruding the liquid dope through a spinerette. The filaments may pass through a curing/drying chamber to solidify the filaments prior to collection. The collected fibers may be combined into a tow band, crimped, and dried. Conventional crimp ratios may be in the range of 1.2 to 1.8. The fibers typically may be packaged in bales that are suitable for later use in filter element formation processes.

The process of forming the actual filter element typically may involve mechanically withdrawing the cellulose acetate tow from the bale and separating the fibers into a ribbon-like band. The tow band may be subjected to a “blooming” process wherein the tow band is separated into individual fibers. Blooming may be accomplished, for example, by applying different tensions to adjacent sections of the tow band or applying pneumatic pressure. The bloomed tow band then may pass through a relaxation zone to allow the fibers to contract, followed by passage into a bonding station. The bonding station typically may apply a plasticizer such as triacetin to the bloomed fibers to soften the fibers and allow adjacent fibers to fuse together. The bonding process may form a homogenous mass of fibers with increased rigidity. The bonded tow then may be wrapped in plug wrap and cut into filter rods. Cellulose acetate tow processes are set forth, for example, in U.S. Pat. Nos. 2,953,838 to Crawford et al. and 2,794,239 to Crawford et al., which are incorporated by reference herein.

Paper-based filter elements may differ from cellulose acetate filter elements in several respects. For example, paper-based filter elements may exhibit greater nicotine filtration efficiency and/or water removal efficiency with respect to cellulose acetate filter elements. Paper-based filter elements also may exhibit greater particulate filtration efficiency compared to cellulose acetate filter elements. Research suggests that a paper filter element may remove significantly more particles, especially particles having diameters greater than about 115 nm, from mainstream smoke than a cellulose acetate filter element. Various paper filter parameters such as, for example, fiber size, fiber orientation, and overall filter porosity may affect the particulate removal efficiencies (e.g., the effective single fiber removal efficiency) of a paper filter for various removal mechanisms including, for example, diffusion, interception, and impaction. Paper-based filter elements also may exhibit reduced phenolic semi-volatile compound removal efficiency with respect to cellulose acetate filter elements. Smoking articles having paper-based filter elements may provide a different smoke flavor profile than those having cellulose acetate filter elements. The different flavor profiles may be related to, for example, greater particulate and/or nicotine filtration efficiencies, greater water removal efficiencies, and/or lower semi-volatile compound removal efficiencies of paper-based filter elements with respect to cellulose acetate filter elements. The different flavor profiles also may be related to, for example, the presence of large voids in paper-based filter elements, absence of triacetin or other plasticizer in paper-based filter elements, and/or differences in the surface chemistries of paper-based filter elements relative to cellulose acetate filter elements.

A process for making paper-based filter elements typically may begin with gathering a sheet of the paper composition. The paper may be gathered; embossed and gathered; corrugated and gathered; or embossed, corrugated, and gathered to form the filter segment. Typically, for a filter element having a circumference of about 22 mm to about 25 mm, the paper which may be gathered to form a filter segment may have a width of about 3.5 inches to about 11 inches, and usually about 5 inches to about 8.5 inches. Gathered paper filter segments may be provided in a variety of manners, including (i) using the apparatus described in U.S. Pat. No. 4,807,809 to Pryor, et al.; (ii) using the apparatus generally as described by Keith, et al., in U.S. Pat. No. 4,283,186 at col. 4, line 50 through col. 5, line 6; and (iii) using a rod making unit available as CU-10, CU-20, or CU-20S from Decoufle s.a.r.b., together with a KDF-2 rod making apparatus from Hauni-Werke Korber & Co., K.G.

Filter segments may be provided by simultaneously gathering two types of paper webs, so as to provide a segment having two types of gathered papers. Although not as desirable, filter segments may be provided by simultaneously gathering a paper web and a web of thermoplastic material (e.g., as described in U.S. Pat. Nos. 5,076,295 to Saintsing et al. and 5,105,835 to Drewett et al.), so as to provide a segment having two types of gathered webs. Filter segments may be plug tube combined with one or more other filter segments (e.g., with a segment of gathered polypropylene web, gathered cellulose acetate web, gathered polyester web, or cellulose acetate tow) using known plug tube combination techniques.

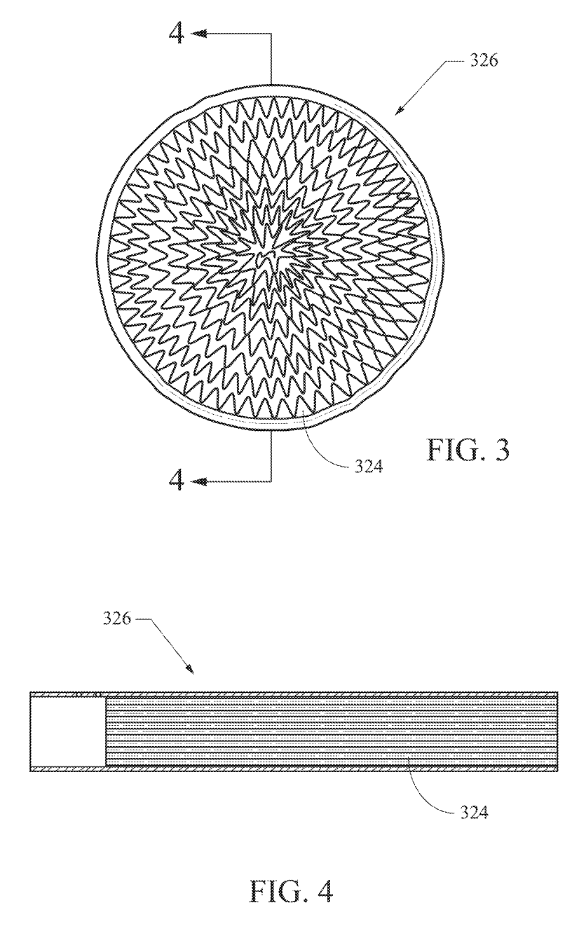

The paper may be gathered to form filter segments 326 (e.g., as shown in the end view and longitudinal section view of FIGS. 3 and 4, respectively) such that the cross sectional void area of that segment typically may range from about 5 to about 30 percent, generally from about 8 to about 25 percent, and often about 10 to about 20 percent. The cross sectional void area (i.e., that area provided by passageways when the filter segment is viewed end-on) typically may be determined using an image analysis technique using an IBAS 2000 Image Analyzer available from Carl Ziess, Inc.

In one aspect, the gathered paper may be corrugated. The corrugations may extend along the length of the paper which may be gathered to provide the filter segment. The corrugation pattern may vary, and may have a wavy, square wave, or saw tooth configuration, when viewed end-on. For example, the paper may be corrugated so as to have a wavy shape when viewed end on, such that the distance between each peak of the corrugation pattern may be about 0.5 to about 2 mm. As another example, the paper may be corrugated such that the distance between each peak of the corrugation pattern may be about 0.3 to about 1 mm, the depth of the corrugation pattern may be about 0.2 to about 1 mm, and the corrugation pattern may be such that each peak may be slightly flattened, and each trough may be slightly flattened.

The manner in which the paper may be embossed or corrugated may vary. In certain circumstances, it may be desirable to moisten the paper prior to the time it may be embossed or corrugated. For example, a paper web having a moisture content of about 10 weight percent may be sprayed with water or otherwise contacted with water so as to achieve a moisture content of about 30 to about 50 weight percent. The moistened paper then may be embossed or corrugated in the presence of applied heat (e.g., at about 120° C.). The moistened paper then may be dried convectively or using microwave drying techniques to a moisture content of about 10 weight percent. The dried, embossed, and/or corrugated paper web then may be gathered into a continuous rod. The continuous rod may be divided into filter rods of the desired length.

A filter segment, such as filter segment 326 shown in FIGS. 3 and 4, may be provided using a gathered paper and may include a plurality of longitudinally extending channels or passageways 324. Often, channels or passageways 324 may extend an entire length of the filter segment. The coated paper may be gathered such that aerosol particles of the mainstream smoke may pass through the longitudinally extending passageways and tend not to physically interact (e.g., impact) with various constituent components of the paper (e.g., the paper composition and/or the coating composition) to a significant degree, while gas phase components of the mainstream smoke may exhibit a tendency to interact physically and chemically with those components of the paper to a significant degree. As the air passageways or channels may be formed by gathering a paper web, the individual channels of the plurality of channels may be of varying shape and size. The number of channels or passageways 324 which may extend longitudinally through the filter segment 326 may vary. Typically, embossed or corrugated papers which may be gathered provide a greater number of longitudinally extending channels than those papers which simply may be gathered without first being embossed or corrugated.

For example, a rod having a circumference of about 23 mm to about 25 mm which may be provided by gathering a corrugated paper (e.g., a paper having a width of about 5.5 inches which may be corrugated), the number of longitudinally extending passageways typically may range from about 100 to about 200, often about 120 to about 180, and frequently about 130 to about 160. Typically, the area of each of such passageways when the filter segment is viewed end-on may range from about 0.05 to about 0.3 mm², often about 0.06 to about 0.2 mm², and frequently about 0.07 to about 0.17 mm². For a rod having a circumference of about 23 mm to about 25 mm which may be provided by gathering a paper (e.g., a paper having a width of about 8.5 inches), the number of longitudinally extending passageways typically may range from about 45 to about 100, often about 50 to about 95, and frequently about 60 to about 80. Typically, the area of each of such passageways when the filter segment is viewed end-on may range from about 0.01 to about 0.2 mm², often about 0.02 to about 0.1 mm², and frequently about 0.03 to about 0.07 mm².

In certain embodiments, the paper may be gathered within the entire cross-sectional region of the filter segment. As such, the paper and air passageways provided by gathering the paper may fill the entire cross sectional region of the filter segment. In addition, the filter segment may be absent of any passageways of extremely large cross sectional area. Preferably, the filter segment may be absent of any air passageways having an area of more than about 1 mm², and most preferably may be absent of any passageways having an area of more than about 2 mm², when the filter segment is viewed end-on.

Processes for manufacturing filters in accordance with the present invention may be substantially similar to those processes described above with respect to traditional paper or cellulose acetate tow filters. Each of the biodegradable materials described herein may be processed in a manner known in the art to form filters (e.g. as gathered papers, tow fibers, fibers derived by fibrillating films, non-wovens formed by melt blown and wet laid processes). As described above, the fibers (including fibers applied to paper compositions and/or other fiber substrates) may be coated with cellulose acetate during or after formation. Alternatively, or in addition, the fibers and/or paper compositions may be treated during assembly into the construction of filters (whether in individual form, multi-filter rods, or other construction formats known in the art).

In one embodiment of the present disclosure, a paper composition substrate may be coated with cellulose acetate and/or flocked with cellulose acetate fibers or other biodegradable fibers coated with cellulose acetate as described herein and gathered to form filter segments using known techniques or techniques developed and used in the future. A resulting filter may have surface chemistries more closely resembling those of traditional cellulose acetate tow filters and biodegradability characteristics more closely resembling those of traditional paper filters. Biodegradability characteristics may be further enhanced by synergistic effects of combinations of paper compositions and cellulose acetate. The fibers that may be disposed on the surfaces of the coated paper may extend axially from the paper surfaces into the longitudinally extending channels or passageways of a filter segment. The fiber extensions may provide for increased mechanical and/or chemical interaction relative to a traditional paper filter between the various components of the mainstream aerosol and the various components of the filter segment during use of a smoking article incorporating the filter. In other words, the flocked fibers may be deposited on the surface of the biodegradable substrate material and configured to extend axially within the longitudinal channels or passageways to contact the mainstream aerosol flowing therethrough. The flocked fibers may extend in a direction transverse to the longitudinal axis of the filter segment or in any other direction relative to the longitudinal axis of the filter segment. A flavor profile may be achieved thereby that more closely resembles that of traditional cellulose acetate filters than traditional paper filters. Some smokers may find this to be desirable.

In another embodiment of the present disclosure, a paper composition substrate may be coated and/or fibrillated as described herein and gathered to form filter segments using known or developed techniques. A resulting filter may have portions of fibrillated paper and/or cellulose acetate film extending axially from the paper surfaces into the longitudinally extending channels or passageways of the filter segments. Stated differently, the fibrillated fibers (e.g., paper material fibers and/or coated paper material fibers) that may be generated by fibrillating the biodegradable substrate material may protrude beyond the surface of the biodegradable substrate material axially within the longitudinal channels or passageways which may provide for increased mechanical and/or chemical interaction with mainstream aerosol as described herein. The fibrillated fibers may extend in a direction transverse to the longitudinal axis of the filter segment or in any other direction relative to the longitudinal axis of the filter segment.

Filter element components or segments for filter elements for multi-segment filtered cigarettes typically may be provided from filter rods produced using traditional types of rod-forming units, such as those available as KDF-2 and KDF-3E from Hauni-Werke Korber & Co. KG. Typically, filter material, such as filter tow, may be provided using a tow processing unit. An exemplary tow processing unit has been commercially available as E-60 supplied by Arjay Equipment Corp., Winston-Salem, N.C. Other exemplary tow processing units have been commercially available as AF-2, AF-3, and AF-4 from Hauni-Werke Korber & Co. KG. In addition, representative manners and methods for operating a filter material supply units and filter-making units are set forth in U.S. Pat. Nos. 4,281,671 to Byrne; 4,862,905 to Green, Jr. et al.; 5,060,664 to Siems et al.; 5,387,285 to Rivers; and 7,074,170 to Lanier, Jr. et al. Other types of technologies for supplying filter materials to a filter rod-forming unit are set forth in U.S. Pat. Nos. 4,807,809 to Pryor et al. and 5,025,814 to Raker; which are incorporated herein by reference.

Cigarette filter rods, including those made in accordance with the presently disclosed embodiments, may be used to provide multi-segment filter rods. The production of multi-segment filter rods may be carried out using the types of rod-forming units that traditionally have been employed to provide multi-segment cigarette filter components. Multi-segment cigarette filter rods may be manufactured using a cigarette filter rod making device available under the brand name Mulfi from Hauni-Werke Korber & Co. KG of Hamburg, Germany. Representative types of filter designs and components, including representative types of segmented cigarette filters, are set forth in U.S. Pat. Nos. 4,920,990 to Lawrence et al.; 5,012,829 to Thesing et al.; 5,025,814 to Raker; 5,074,320 to Jones, Jr. et al.; 5,105,838 to White et al.; 5,271,419 to Arzonico et al.; 5,360,023 to Blakley et al.; 5,396,909 to Gentry et al.; 5,718,250 to Banerjee et al.; 6,761,174 to Jupe et al.; 7,836,895 to Dube et al.; 7,240,678 to Crooks et al.; and 7,568,485 to Zhang; U.S. Pat. Appl. Pub. Nos. 2006/0090769 to Woodson et al.; 2006/0144412 to Mishra et al.; 2006/0157070 to Belcastro et al.; and 2007/0056600 to Coleman, III et al.; and PCT Publication Nos. WO 03/009711 to Kim and WO 03/047836 to Xue et al.; all of which are incorporated by reference herein.

Multi-segment filter elements typically may be provided from so-called “six-up” filter rods, “four-up” filter rods and “two-up” filter rods that are of the general format and configuration conventionally used for the manufacture of filtered cigarettes and may be handled using conventional-type or suitably modified cigarette rod handling devices, such as tipping devices available as Lab MAX, MAX, MAX S or MAX 80 from Hauni-Werke Korber & Co. KG. See, for example, the types of devices set forth in U.S. Pat. Nos. 3,308,600 to Erdmann et al.; 4,281,670 to Heitmann et al.; 4,280,187 to Reuland et al.; 4,850,301 to Greene, Jr. et al.; 6,229,115 to Vos et al.; 7,434,585 to Holmes; and 7,296,578 to Read, Jr.; and U.S. Pat. Appl. Pub. No. 2006/0169295 to Draghetti, each of which is incorporated by reference herein.

Filter elements of the present invention may be incorporated within the types of cigarettes set forth in U.S. Pat. Nos. 4,756,318 to Clearman et al.; 4,714,082 to Banerjee et al.; 4,771,795 to White et al.; 4,793,365 to Sensabaugh et al.; 4,989,619 to Clearman et al.; 4,917,128 to Clearman et al.; 4,961,438 to Korte; 4,966,171 to Serrano et al.; 4,969,476 to Bale et al.; 4,991,606 to Serrano et al.; 5,020,548 to Farrier et al.; 5,027,836 to Shannon et al.; 5,033,483 to Clearman et al.; 5,040,551 to Schlatter et al.; 5,050,621 to Creighton et al.; 5,052,413 to Baker et al.; 5,065,776 to Lawson; 5,076,296 to Nystrom et al.; 5,076,297 to Farrier et al.; 5,099,861 to Clearman et al.; 5,105,835 to Drewett et al.; 5,105,837 to Barnes et al.; 5,115,820 to Hauser et al.; 5,148,821 to Best et al.; 5,159,940 to Hayward et al.; 5,178,167 to Riggs et al.; 5,183,062 to Clearman et al.; 5,211,684 to Shannon et al.; 5,240,014 to Deevi et al.; 5,240,016 to Nichols et al.; 5,345,955 to Clearman et al.; 5,396,911 to Casey, III et al.; 5,551,451 to Riggs et al.; 5,595,577 to Bensalem et al.; 5,727,571 to Meiring et al.; 5,819,751 to Barnes et al.; 6,089,857 to Matsuura et al.; 6,095,152 to Beven et al; and 6,578,584 to Beven; which are incorporated by reference herein. Still further, filter elements of the present invention may be incorporated within the types of cigarettes that have been commercially marketed under the brand names “Premier” and “Eclipse” by R. J. Reynolds Tobacco Company. See, for example, those types of cigarettes described in Chemical and Biological Studies on New Cigarette Prototypes that Heat Instead of Burn Tobacco, R. J. Reynolds Tobacco Company Monograph (1988) and Inhalation Toxicology, 12:5, p. 1-58 (2000); which are incorporated by reference herein.

During manufacture of typical cigarette filters, two types of adhesives commonly may be used to secure plug wrap and/or tipping paper around the filter material, and/or within the filter itself: (1) a hot melt adhesive for gluing the edges of the plug wrap, and (2) an aqueous dispersion based adhesive for gluing the tipping paper. Although the physical form of these adhesives may be different, both types typically may include ethylene vinyl acetate as the main polymeric ingredient. Ethylene vinyl acetate generally may not be considered a readily biodegradable polymer. In formulating cigarette filters for accelerated degradability (e.g., by employing structures disclosed herein, or forming a filter from papers and/or polymers that have demonstrated accelerated biodegradability), it may be desirable that the adhesive that holds the filter material together within the two layers of paper is also biodegradable. Certain biodegradable adhesives may be used in cigarette filters as hot melts and as aqueous dispersions. Biodegradable polymers that may be used directly as hot melts or used after blending with commonly used plasticizers and tackifiers are commercially available Biodegradable polymers that may be applied as aqueous dispersions may be used as tipping glue after converting them to dispersions by one or more of several methods. Commercially available biodegradable polymers and methods of converting biodegradable polymers to dispersions are described in U.S. Pat. Appl. Ser. No. 12/963,275, filed Dec. 8, 2010.

Cigarette rods typically may be manufactured using a cigarette making machine, such as a conventional automated cigarette rod making machine. Exemplary cigarette rod making machines and the components and operations thereof are described in U.S. patent application Ser. No. 12/963,275, filed Dec. 8, 2010. Automated cigarette making machines may provide a formed continuous cigarette rod or smokable rod that may be subdivided into formed smokable rods of desired lengths.

Those of skill in the art will appreciate that embodiments not expressly illustrated herein may be practiced within the scope of the present invention, including that features described herein for different embodiments may be combined with each other and/or with currently-known or future-developed technologies while remaining within the scope of the claims presented herein. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment of the invention.

1. A filter material configured for use as part of a smoking article, comprising:
a biodegradable substrate material;
a coating composition disposed upon at least one surface of the biodegradable substrate material; and
a plurality of fibers protruding beyond the at least one surface of the biodegradable substrate material.

2. The filter material of claim 1, wherein the biodegradable substrate material comprises a paper composition.

3. The filter material of claim 1, wherein the coating composition comprises at least one of cellulose acetate and plasticized cellulose acetate.

4. The filter material of claim 1, wherein each of the plurality of fibers comprises at least one material selected from the group consisting of: cellulose acetate, plasticized cellulose acetate, a polyhydroxyalkanoate, polylactic acid, a polycaprolactone, polybutylene succinate adipate, polyvinyl alcohol, starch, regenerated cellulose, paper material, and a polyesteramide.

5. The filter material of claim 4, wherein the plurality of fibers comprises a coating composition disposed upon at least one of the plurality of fibers, the coating composition comprising at least one of cellulose acetate and plasticized cellulose acetate.

6. The filter material of claim 1, wherein the plurality of fibers comprises at least one flocked fiber deposited on a surface of the biodegradable substrate material by flocking.

7. The filter material of claim 1, wherein the plurality of fibers comprises at least one fibrillated fiber generated on a surface of the biodegradable substrate material by fibrillation.

8. A smoking article comprising the filter material of claim 1.

9. A method of making the filter material of claim 1, the method comprising:
coating the at least one surface of the biodegradable substrate material with the coating composition; and
depositing the plurality of fibers on the at least one surface of the coated biodegradable substrate material by flocking.

10. The method of claim 9, wherein the biodegradable substrate material comprises a paper composition and the coating composition comprises at least one of cellulose acetate and plasticized cellulose acetate.

11. The method of claim 9, wherein each of the plurality of fibers comprises at least one material selected from the group consisting of: cellulose acetate, plasticized cellulose acetate, a polyhydroxyalkanoate, polylactic acid, a polycaprolactone, polybutylene succinate adipate, polyvinyl alcohol, starch, regenerated cellulose, paper material, and a polyesteramide.

12. The method of claim 11, wherein the plurality of fibers comprises a coating of at least one of cellulose acetate and plasticized cellulose acetate disposed upon at least one of the plurality of fibers.

13. A method of making the filter material of claim 1, the method comprising:
coating the at least one surface of the biodegradable substrate material with the coating composition; and
fibrillating the coated biodegradable substrate material to generate the plurality of fibers.

14. The method of claim 13, wherein the biodegradable substrate material comprises a paper composition.

15. The method of claim 13, wherein the coating composition comprises at least one of cellulose acetate and plasticized cellulose acetate.

16. A filter element configured for use as part of a smoking article, comprising:
a filter material comprising a biodegradable substrate material, a coating composition disposed upon at least one surface of the biodegradable substrate material, and a plurality of fibers protruding beyond the at least one surface of the biodegradable substrate material.

17. The filter element of claim 16, wherein the filter element is configured as a gathered paper having at least one longitudinal passageway extending longitudinally therein, and at least one of the plurality of fibers is configured to extend axially within the at least one longitudinal passageway to contact mainstream aerosol disposed therein.

18. The filter element of claim 16, wherein at least one of the plurality of fibers is deposited upon the at least one surface of the biodegradable substrate material by flocking.

19. The filter element of claim 18, wherein each of the plurality of fibers comprises at least one material selected from the group consisting of: cellulose acetate, plasticized cellulose acetate, a polyhydroxyalkanoate, polylactic acid, a polycaprolactone, polybutylene succinate adipate, polyvinyl alcohol, starch, regenerated cellulose, paper material, and a polyesteramide.

20. The filter element of claim 19, wherein the plurality of fibers comprises a coating of at least one of cellulose acetate and plasticized cellulose acetate disposed upon at least one of the plurality of fibers.

21. The filter element of claim 16, wherein at least one of the plurality of fibers is produced by fibrillating the filter material.

22. A smoking article comprising the filter element of claim 16.
